(19) United States
(12) Patent Application Publication
(10) Pub. No.: US 2009/0138583 A1
(43) Pub. Date: May 28, 2009

(54) METHOD AND APPARATUS FOR GENERATING STATISTICS ON INFORMATION TECHNOLOGY SERVICE MANAGEMENT PROBLEMS AMONG ASSETS

(76) Inventors: Rhonda L. Childress, Austin, TX (US); David Bruce Kumhyr, Austin, TX (US); Stephen James Watt, Cedar Park, TX (US)

Correspondence Address: IBM CORP (YA);C/O YEE & ASSOCIATES PC, P.O. BOX 802333, DALLAS, TX, 75380, US

(21) Appl. No.: 11/946,725

(22) Filed: Nov. 28, 2007

(51) Int. Cl. G06F 15/173

(52) U.S. Cl. 709/223

(57) ABSTRACT

The illustrative embodiments described herein provide a computer implemented method, apparatus, and computer program product for generating a set of statistics on information technology service management problems among assets within a network. A data processing system monitors the network for a systems management system message containing information associated with a reported problem of an asset within the network. The systems management system message is generated by the asset associated with the reported problem. Responsive to detecting the systems management system message, the data processing system stores the information associated with the reported problem of the asset contained in the systems management system message to a set of stored data. The data processing system generates the set of statistics on information technology service management problems among the assets within the network using the set of stored data.

### CROSS-REFERENCE TO RELATED APPLICATIONS

The present application is related to the following applications entitled “METHOD AND APPARATUS FOR ASSOCIATING HELP DESK TICKET WITH AFFECTED DATA PROCESSING SYSTEM”, Ser. No. ______, attorney docket no. AUS920070020US1; and “METHOD AND APPARATUS FOR EXPOSING INFORMATION TECHNOLOGY SERVICE MANAGEMENT PROBLEMS TO A SYSTEMS MANAGEMENT SYSTEM”, Ser. No. ______, attorney docket no. AUS920070021US1; filed on even date hereof, assigned to the same assignee, and incorporated herein by reference.

### BACKGROUND OF THE INVENTION

1. Field of the Invention

The present invention relates generally to the data processing field. Still more particularly, the present invention relates to a computer implemented method, apparatus, and computer program product for generating statistics on information technology service management problems among assets.

2. Description of the Related Art

Information technology service management (ITSM) is a discipline for managing information technology (IT) systems. Information technology service management focuses on providing customer satisfaction in regards to the use of information technology. A service facility, also known as a help desk, is a primary component of information technology service management.

Many organizations provide service facilities to address customer problems. The service facility generally utilizes a help desk software system for keeping track of service calls and for generating a report. The generated report is known as a “help desk ticket”. The help desk ticket identifies the individual reporting the problem and the device affected by the problem. At an appropriate time, a service person, referencing the help desk ticket, will correct the reported problem. The problem may be corrected directly from the help desk, if possible, or by traveling to the location of the affected device.

The type of devices that a help desk ticket may be generated for include, but are not limited to, data processing systems, printers, copiers, scanners, and audio and video recording devices. The data processing systems may include personal workstations and/or servers within the information technology infrastructure. These devices are known as assets of the information technology infrastructure.

The service facility may keep track of statistics associated with reported problems. However, because the service facility may be a third party vendor, the statistics generated by the service facility may be favorably skewed. For example, personnel at the service facility may falsely open and close help desk tickets to drive up their numbers and lower their average resolution times. In addition, difficulty exists in corroborating the service facility's reported progress associated with a reported problem.

Accordingly, it would be advantageous to have a computer implemented method, apparatus, and computer program product for overcoming the problems discussed above.

### SUMMARY OF THE INVENTION

The illustrative embodiments described herein provide a computer implemented method, apparatus, and computer program product for generating a set of statistics on information technology service management problems among assets within a network. A data processing system monitors the network for a systems management system message containing information associated with a reported problem of an asset within the network. The systems management system message is generated by the asset associated with the reported problem. Responsive to detecting the systems management system message, the data processing system stores the information associated with the reported problem of the asset contained in the systems management system message to a set of stored data. The data processing system generates the set of statistics on information technology service management problems among the assets within the network using the set of stored data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 is a pictorial representation of a network of data processing systems in which exemplary embodiments may be implemented;

FIG. 2 is a block diagram of a data processing system in which exemplary embodiments may be implemented;

FIG. 3 is a block diagram of a data processing environment in accordance with an illustrative embodiment; and

FIG. 4 is a flowchart of a process for generating statistics on information technology service management problems among assets in accordance with an illustrative embodiment.

### DETAILED DESCRIPTION OF THE PREFERRED EMBODIMENT

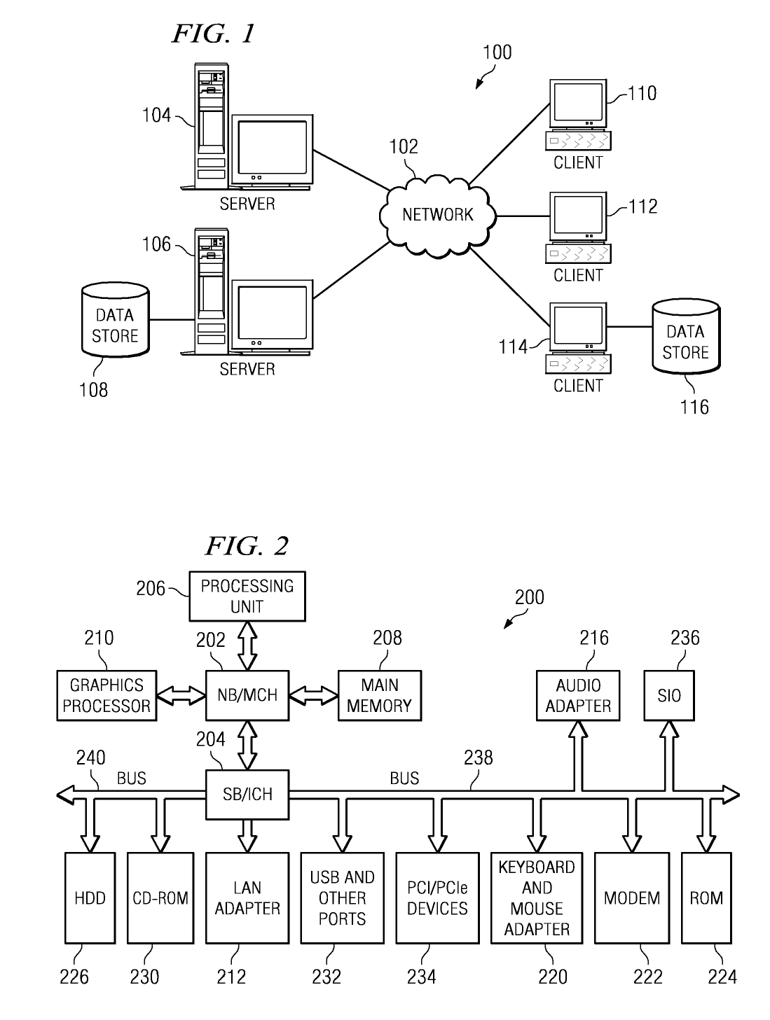

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which exemplary embodiments may be implemented. Network data processing system 100 is a network of computers in which the illustrative embodiments may be implemented. Network data processing system 100 may represent the information technology infrastructure of an organization. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102. Server 104 and server 106 may include a data store, such as data store 108. In this illustrative example, data store 108 is associated with server 106. In addition, clients 110, 112, and 114 connect to network 102. Clients 110, 112, and 114 may be, for example, personal computers or network computers. Clients 110, 112, and 114 may also include a data store, such as data store 116. In the depicted example, clients 110, 112, and 114 are clients to server 106. For example, server 106 may provide data, such as, but not limited to, boot files, operating system images, and applications to clients 110, 112, and 114. Network data processing system 100 may include additional servers, clients, and other devices not shown.

The illustrative embodiments described herein provide a computer implemented method, apparatus, and computer program product for generating a set of statistics on information technology service management problems among assets within a network. The illustrative embodiments may be implemented in a data processing system such as server 104. Server 104 may be part of the information technology infrastructure of an organization. Server 104 may be used to monitor the network traffic of the information technology infrastructure for a systems management system message containing information associated with a reported problem of an asset within the network.

A systems management system message is a message sent to a systems management system application associated with monitoring the assets of the information technology infrastructure. In this illustrative example, clients 110, 112, 114, and server 106, are assets of the network data processing system 100. A systems management system message containing information associated with a reported problem of an asset within the network may be generated by the asset in accordance with, but not limited to, the illustrative embodiments of related application, “Method and Apparatus for Exposing Information Technology Service Management Problems to a Systems Management System.” For example, a systems management system message containing information associated with a reported problem of an asset may be generated by the asset in response to receiving a help desk ticket from a service facility. In addition, a systems management system message may be generated in response to receiving an updated help desk ticket containing information associated with the resolution of the reported problem.

The systems management system message may be sent to the systems management system via a simple network management protocol (SNMP) trap. Simple network management protocol traps enable a systems management system agent executing on the asset to notify the systems management system of events by way of an unsolicited simple network management protocol message. For example, simple network management protocol provides the ability to send traps, or notifications, to advise an administrator when one or more conditions have been met. Traps are network packets that contain data relating to a component of the system sending the trap. The data may be statistical in nature or even status related.

A systems management system, such as, but not limited to, Tivoli® Business Systems Manager (TBSM), Tivoli® Enterprise Console (TEC), NetView®, and HP OpenView® provides information about individual components or resources within the information technology infrastructure of the organization. For example, Tivoli® Business Systems Manager shows operation personnel what business functions are affected by an outage of a single component, such as, but not limited to, a specific server within the infrastructure. Tivoli® Business Systems Manager, Tivoli® Enterprise Console, and NetView® are registered trademarks of International Business Machines Corporation. HP OpenView® is a registered trademark of Hewlett-Packard Development Company, L.P.

Responsive to detecting the systems management system message, server 104 stores the information associated with the reported problem of the asset contained in the systems management system message to a set of stored data. Server 104 generates a set of statistics on information technology service management problems among the assets within the network using the set of stored data. The set of statistics may be presented to a user or stored for further processing by another component. In addition, the set of statistics may be compared with statistics generated by a service facility to corroborate the efficiency of the service facility in handling reported problems.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different exemplary embodiments.

With reference now to FIG. 2, a block diagram of a data processing system is shown in which exemplary embodiments may be implemented. Data processing system 200 is an example of a data processing system, such as server 104 or client 110 in FIG. 1, in which computer usable program code or instructions implementing the processes may be located for the exemplary embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the exemplary embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

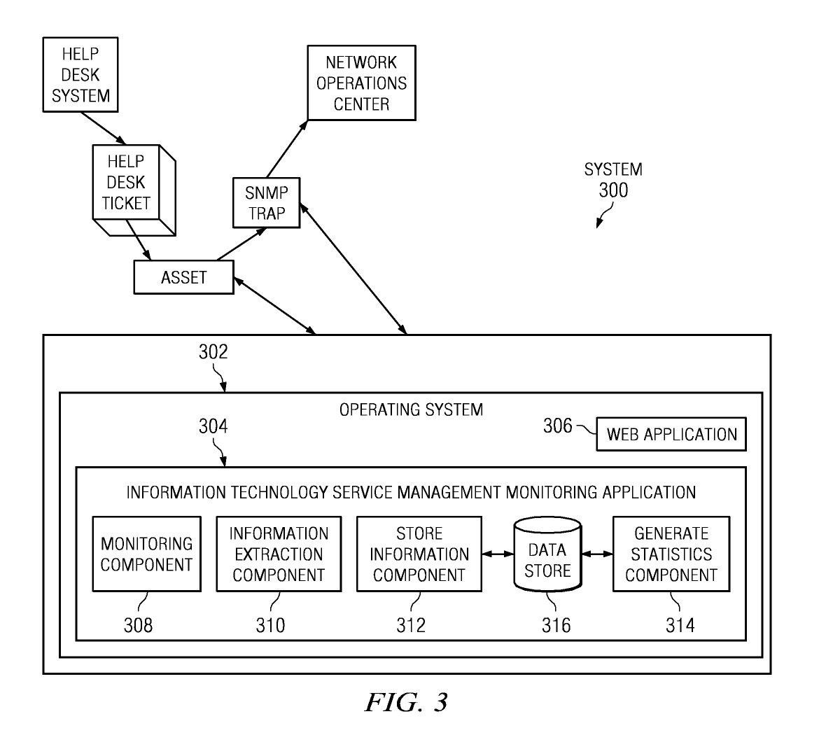

A with reference now to FIG. 3, a block diagram of a data processing environment is depicted in which illustrative embodiments may be implemented. System 300 may be implemented in a data processing system, such as a server 104 shown in FIG. 1, or data processing system 200 shown in FIG. 2. System 300 includes, among other components, operating system 302, information technology service management monitoring application 304 and web application 306.

Operating system 302 runs on system 300. Operating system 302 may be, but is not limited to, any commercially available operating system, such as, for example, Microsoft® Windows Server® operating system. The illustrative embodiments may be implemented in an information technology service management monitoring application 304 running on operating system 302. Additionally, operating system 302 may run other software components or applications, such as web application 306.

In this illustrative embodiment, information technology service management monitoring application 304 comprises of a monitoring component 308, an information extraction component 310, a store information component 312, a generate statistics component 314, and a data store 316. The depicted example is not meant to imply a specific implementation. Information technology service management monitoring application 304 may contain other components not illustrated and/or the depicted components may be combined or omitted in certain implementations.

Monitoring component 308 handles monitoring of the network traffic for a systems management system message containing information associated with a reported problem of an asset within the network. Monitoring component 308 may poll the assets within the network for systems management system messages containing information associated with a reported problem of an asset within the network. Polling a data processing system means querying/asking the data processing system to respond to a question. In this case, the monitoring component 308 queries the assets for systems management system messages containing information associated with a reported problem of an asset within the network. In addition, monitoring component 308 may monitor simple network management protocol (SNMP) traps within the network for systems management system messages containing information associated with a reported problem of an asset within the network.

Information extraction component 310 extracts the information associated with a reported problem of an asset from the detected systems management system messages. Store information component 312 stores the extracted information into a data store, such as data store 316. Data store 316 is a storage system used to store and retrieve information. Data store 316 may be, but is not limited to, a relational database. Data store 316 may comprise of one or more local storage devices/databases or the storage devices/databases may be located on a remote data processing system. Additionally, data store 316 may comprise of data associated with other applications, such as web application 306, or may be a dedicated storage system for information technology service management monitoring application 304.

Generate statistics component 314 uses the information stored in data store 316 to generate a set of statistics associated with information technology service management problems among assets within the network. The information included in the set of statistics may comprise of, but is not limited to, the types of assets, the types of problems associated with the types of assets, solutions associated with the types of problems, and the resolution times associated with the types of problems. The set of statistics may be presented to a user in the form of, but not limited to, a raw statistical report, a pie chart, a histogram showing the quantity of points that fall within various numeric ranges, and a bar graph showing frequencies or values for different categories.

In another illustrative embodiment, the set of statistics is compared to a second set of statistics to generate a comparative report. For example, the second set of statistics may be a set of statistics that is generated by a help desk system. The comparative report may contain a complete set of information comparing the two sets of statistics. Alternatively, the comparative report may contain only the information determined to be contrasting between the two set of statistics. The determination of contrasting statistics may be based on a set of preconfigured parameters. Thus, the comparative report may be used to corroborate statistics reported by a service facility.

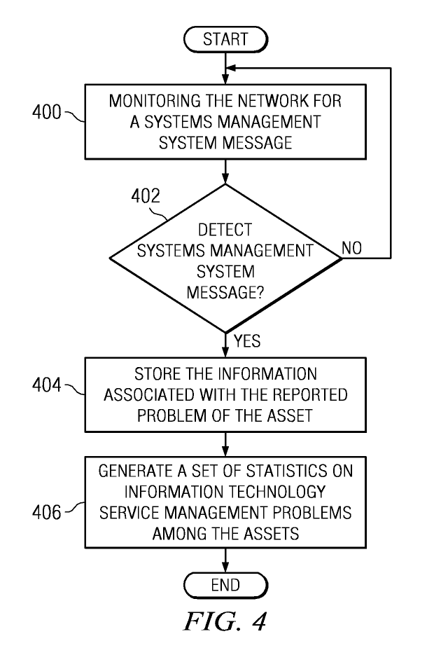

With reference now to FIG. 4, a flowchart of a process for generating statistics on information technology service management problems among assets is depicted in accordance with an illustrative embodiment. The process of FIG. 4 may be implemented in a software component, such as information technology service management monitoring application 304 as shown in FIG. 3.

The process begins by monitoring the network for a systems management system message containing information associated with a reported problem of an asset within the network (step 400). Responsive to detecting the systems management system message (at step 402), the process stores the information associated with the reported problem of the asset contained in the systems management system message to a set of stored data (step 404). The process generates a set of statistics on information technology service management problems among the assets within the network using the set of stored data (step 406), with the process terminating thereafter.

Accordingly, the illustrative embodiments described herein provide a computer implemented method, apparatus, and computer program product for generating a set of statistics on information technology service management problems among assets within a network. A data processing system monitors the network for a systems management system message containing information associated with a reported problem of an asset within the network. The systems management system message is generated by the asset associated with the reported problem. Responsive to detecting the systems management system message, the data processing system stores the information associated with the reported problem of the asset contained in the systems management system message to a set of stored data. The data processing system generates the set of statistics on information technology service management problems among the assets within the network using the set of stored data.

The set of statistics may be presented to a user in a variety of formats providing useful information about the effectiveness and efficiency of a service facility associated with the information technology infrastructure of an organization. Additionally, the set of statistics may be compared to statistics reported by the service facility to corroborate the accuracy of such reports. The monitoring process of the illustrative embodiments may also be used to verify the progress of reported problems associated with assets within the network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating a set of statistics on information technology service management problems among assets within a network, the computer implemented method comprising:
monitoring the network for a systems management system message containing information associated with a reported problem of an asset within the network, wherein the systems management system message is generated by the asset associated with the reported problem;
responsive to detecting the systems management system message, storing the information associated with the reported problem of the asset contained in the systems management system message to a set of stored data; and
generating the set of statistics on information technology service management problems among the assets within the network using the set of stored data.

2. The computer implemented method of claim 1, wherein the systems management system message is sent using a simple network management protocol (SNMP) trap.

3. The computer implemented method of claim 1, wherein monitoring the network includes polling the assets within the network for the systems management system message containing information associated with the reported problem of an asset.

4. The computer implemented method of claim 1, wherein monitoring the network includes receiving the systems management system message from a simple network management protocol (SNMP) trap.

5. The computer implemented method of claim 1, wherein the set of statistics comprises of types of assets, types of problems associated with the types of assets, solutions associated with the types of problems, and a resolution time associated with the types of problems.

6. The computer implemented method of claim 1, further comprising:
comparing the set of statistics to a second set of statistics to generate a comparative report, wherein the second set of statistics is generated by a help desk system.

7. A computer program product comprising:
a computer usable medium including computer usable program code for generating a set of statistics on information technology service management problems among assets within a network, the computer program product comprising:
computer usable program code for monitoring the network for a systems management system message containing information associated with a reported problem of an asset within the network, wherein the systems management system message is generated by the asset associated with the reported problem;
computer usable program code for storing the information associated with the reported problem of the asset contained in the systems management system message to a set of stored data in response to detecting the systems management system message; and
computer usable program code for generating the set of statistics on information technology service management problems among the assets within the network using the set of stored data.

8. The computer program product of claim 7, wherein the systems management system message is sent using a simple network management protocol (SNMP) trap.

9. The computer program product of claim 7, wherein the computer usable program code for monitoring the network includes computer usable program code for polling the assets within the network for the systems management system message containing information associated with the reported problem of an asset.

10. The computer program product of claim 7, wherein the computer usable program code for monitoring the network includes computer usable program code for receiving the systems management system message from a simple network management protocol (SNMP) trap.

11. The computer program product of claim 7, wherein the set of statistics comprises of types of assets, types of problems associated with the types of assets, solutions associated with the types of problems, and a resolution time associated with the types of problems.

12. The computer program product of claim 7, further comprising:
computer usable program code for comparing the set of statistics to a second set of statistics to generate a comparative report, wherein the second set of statistics is generated by a help desk system.

13. An apparatus comprising:
a bus system;
a communications system connected to the bus system;
a memory connected to the bus system, wherein the memory includes computer usable program code; and a process unit connected to the bus system, wherein the process unit executes the computer usable program code to monitor the network for a systems management system message containing information associated with a reported problem of an asset within the network, wherein the systems management system message is generated by the asset associated with the reported problem; store the information associated with the reported problem of the asset contained in the systems management system message to a set of stored data in response to detecting the systems management system message; generate the set of statistics on information technology service management problems among the assets within the network using the set of stored data.

14. The apparatus of claim 13, wherein the systems management system message is sent using a simple network management protocol (SNMP) trap.

15. The apparatus of claim 13, wherein the computer usable program code to monitor the network includes computer usable program code to poll the assets within the network for the systems management system message containing information associated with the reported problem of an asset.

16. The apparatus of claim 13, wherein the computer usable program code to monitor the network includes computer usable program code to receive the systems management system message from a simple network management protocol (SNMP) trap.

17. The apparatus of claim 13, wherein the set of statistics comprises of types of assets, types of problems associated with the types of assets, solutions associated with the types of problems, and a resolution time associated with the types of problems.

18. The apparatus of claim 13, further comprising:
computer usable program code to compare the set of statistics to a second set of statistics to generate a comparative report, wherein the second set of statistics is generated by a help desk system.
